(19) United States
(12) Patent Application Publication
(10) Pub. No.: US 2005/0142043 A1
(43) Pub. Date: Jun. 30, 2005

(54) Hot end systems including an insertable inner cone

(76) Inventors: Eric C. Pekrul, Beulah, MI (US); Ashraf K. Pindari, Cambridge (CA)

Correspondence Address: HARNESS, DICKEY & PIERCE, P.L.C., P.O. BOX 828, BLOOMFIELD HILLS, MI, 48303, US

(21) Appl. No.: 11/005,570

(22) Filed: Dec. 6, 2004

Related U.S. Application Data
(60) Provisional application No. 60/527,314, filed on Dec. 5, 2003.

(51) Int. Cl. F01N 3/28; B01D 53/34

(52) U.S. Cl. 422/179; 422/177; 422/180

(57) ABSTRACT

The present invention relates to an exhaust end cone assembly including an outer end cone which is formed from a cast iron alloy and an inner end cone disposed within the outer end cone which is formed from a heat resistant material. The inner end cone is shaped such that an air gap occurs along a significant portion of the area between the inner and outer end cones to provide thermal advantages to the assembly.

### CROSS-REFERENCE TO RELATED APPLICATIONS

This application claims the benefit of U.S. Provisional Application No. 60/527,314, filed on Dec. 5, 2003. The disclosure(s) of the above application(s) is (are) incorporated herein by reference.

### BACKGROUND OF THE INVENTION

End cones for exhaust conversion assemblies, otherwise referred to herein as hot end systems, employing catalytic converters increasingly require accommodations for thermal heat management. One of the chief functions of the end cones is to transition the diameter from the inlet/outlet pipes to the diameter of the substrate and to evenly distribute the exhaust gas over the face of a catalytic converter substrate. In so doing, the end cones are invariably subjected to extreme exhaust gas impingement, high exhaust gas flow velocities and temperatures.

If the design geometry is not optimized, turbulence invariably occurs which accelerates the heat transfer from the exhaust stream into the end cones. These facts have several detrimental effects to the durability of the converter. Most significant is the exhaust heat has a direct path from the end cone into the main body (container) of the converter, thus raising the exterior temperature of the container and mounting mat. The mounting mat is designed to hold the substrate by “taking up” and limiting the thermal growth differential between the converter housing and the substrate. One way it accomplishes this is by insulating the converter housing, otherwise known in the art as the converter can, from the hot substrate thus lowering the temperature of the can and limiting its thermal growth. The mat is under compression, which with its friction provides the holding force for the substrate and expands to fill the gap differential between the substrate and can caused by their differing thermal growths. Therefore, any mechanism that increases the can temperature is detrimental to the converter durability as it will increase the gap between the can and substrate, which decreases the holding force, imparted by the mat and raises the overall mat temperature reducing its life. Other detrimental effects in more extreme cases are from erosion of the end cones due to exhaust gas impingement and thermal heat loss of the exhaust gas before it reaches the substrate causing increased lit off times and reduced conversion efficiency.

### DISCUSSION OF PRIOR ART

Currently known end cones use rolled and formed stainless steel for both inner and outer cones. Further, such end cones do not employ air gaps and/or insulation in the manner described in the present invention.

Still other prior art employs cast-in heat shields that require special casting processes that may be prohibitively expensive. The construction of various known end cone assemblies are unduly complicated and often require welding with expensive alloys to accomplish a robust weld.

### SUMMARY OF THE INVENTION

The present invention relates to exhaust system end cone assemblies comprising an outer end cone and an insertable inner end cone which is disposed within the outer end cone in at least partially spaced relationship to provide a gap between the inner and outer end cones. The air gap, which serves as a thermal barrier, optionally including thermal insulation, protects the cast iron end cone and converter housing from extreme temperatures and may eliminate the need for external heat shields to protect other under hood components. More particularly, the present invention describes a way of capturing an inner cone, made of heat resistant material, in a way that requires no welding, crimping or fastening in a conventional way.

The inner cone is not called upon to have great strength, it only needs to have enough strength to support itself and some light insulation. Therefore a fairly light section is usually all that's required, which helps improve thermal inertia. Its main function is to protect the outer cone from direct exhaust gas impingement lowering its temperature and therefore reducing the heat transfer into the main body of the converter.

### DESCRIPTION OF THE FIGURES

FIG. 1 is a sectional view of an exhaust system end cone assembly embodiment including an insertable inner cone according to the teachings of the present invention;

FIG. 2 is a cross-sectional view taken along line 2-2 of FIG. 1;

FIG. 3 is a cross-sectional view demonstrating an alternative outer end cone flange design taken along the same cross-section as line 2-2;

FIG. 4 is a partial cross-sectional view of the outer end cone flange design of FIG. 3 including an inner end cone having outwardly projecting beads;

FIG. 5 is a sectional view of an alternative exhaust system end cone assembly according to the teachings of the present invention; and

FIG. 6 is a cross-sectional view taken along line 6—6 of FIG. 5 absent the inner end cone.

### DETAILED DESCRIPTION OF THE INVENTION

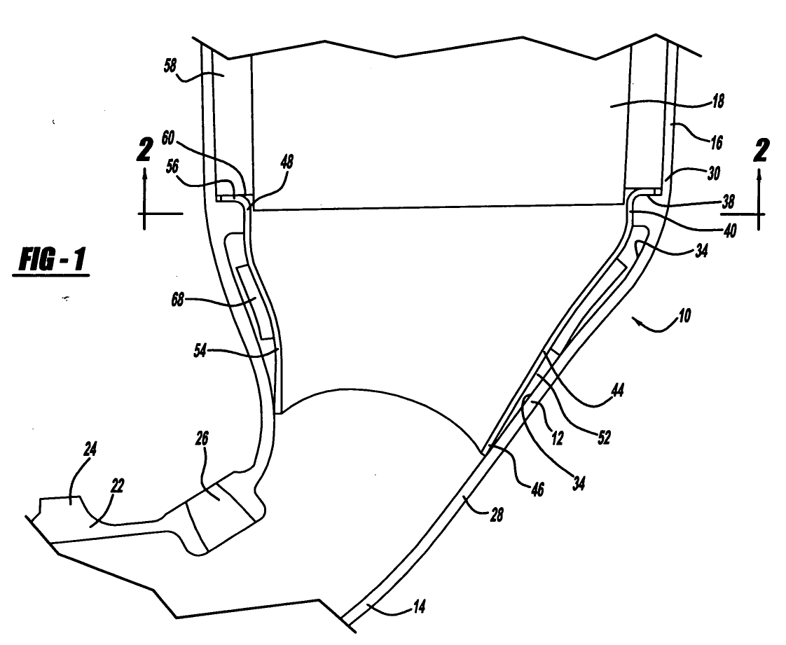

A catalytic converter end cone assembly 10 having a dual wall air gap for improved thermal heat management is illustrated in FIG. 1. While the end cone assembly described herein is considered to be applicable to either the inlet side or outlet side of a catalytic converter assembly, as should be appreciated by those of ordinary skill in the art reference will now be made to an inlet end application for purposes of describing the invention.

The end cone assembly 10 includes an outer end cone 12 which transitions the inner diameter between the catalytic converter housing 16 and an exhaust gas inlet portion 14. The end cone of the inlet side is intended to assist in evenly distributing the exhaust gas over the face of the catalytic substrate 18 contained within the converter housing that filters the exhaust gases. The inlet portion 14, shown in the form of a transition pipe may include a flange 24 provided along one end 22 for mounting the catalytic converter end cone assembly to other components such as an exhaust manifold (not shown) by way of non-limiting example. The pipe 14 may also include one or more apertures 26 for hosting exhaust gas monitoring sensors (not shown).

At an opposite end 28, the pipe 14 transitions to the outer end cone 12 wherein the internal diameter of the end cone expands to the transition point 30 of the converter housing 16. As shown, the internal diameter of the outer end cone has a substantially fluted shape. The pipe 14, outer end cone 12 and converter housing 16 can be a multiple piece cast assembly or as shown in the form of a one piece casting such as those described in co-pending U.S. patent application Ser. No. 10/812,009 entitled “One Piece Catalytic Converter Housing With Integral End Cone”, which is hereby incorporated by reference. Among the preferred alloys for casting are those known in the art as SiMo cast iron alloys.

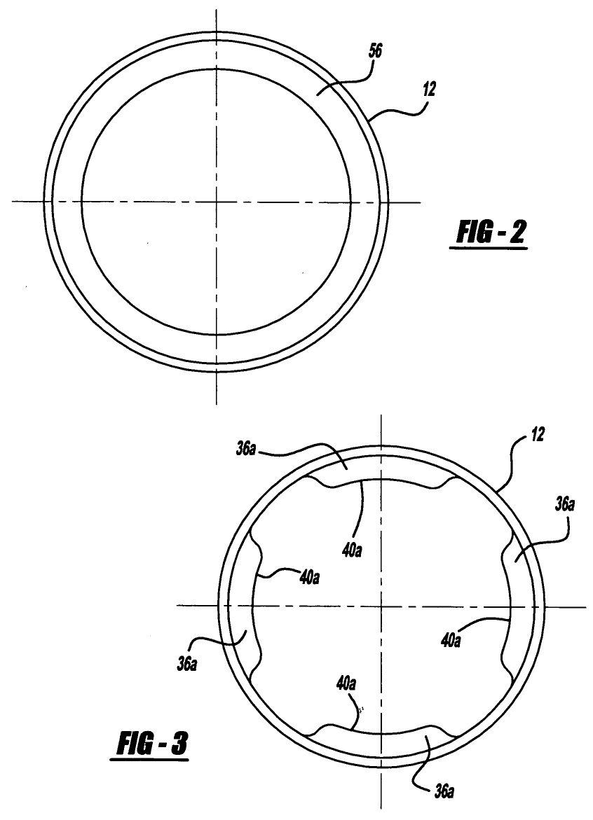

The end cone assembly 10 includes means for cooperatively securing the insertable inner cone 44 within the outer end cone 12. As depicted in FIG. 1, such means include an inwardly extending flange 36 disposed in proximity to the transition point 30 between the outer end cone 12 and converter housing 16. The flange 36 which is typically a cast in feature generally includes a shelf 38 and an inner wall 40. The flange 36 may be continuous as depicted in FIG. 2 or intermittent including various flange sections 36a as depicted in FIG. 3. The inner end cone 44 may optimally include outwardly projecting leads 62 which engage the corners 66 of the intermittent flange sections 36a which prevent the inner core from rotating within the outer end cone 12.

The inner cone 44, which is formed from a heat resistant material such as 439 or 409 stainless steel or ceramics by way of non-limiting example, is sized and shaped to fit within the outer cone 12. More particularly, the second end 48 of the inner cone 44 as shown in FIG. 1, is sized to fit securely against the inner wall 40 of the inwardly projecting flange 36 provided along the inner wall of the outer cone or is sized to fit securely against the inner wall sections 40a of the flange sections 36a of the embodiment of FIG. 3. The second end 48 also includes an outwardly extending lip 56 which rests upon the shelf 38 and is captured, i.e., entrapped along an end 60 of the mounting mat 58 upon full insertion into the converter housing 16.

At the opposite end 46 the inner cone 44 is sized to seat against the inner wall 34 of the outer end cone 12. The body 50 of the inner cone diverges from the second end 48 toward the first end 46 such that an air gap 52 is provided between the inner wall 34 of the outer end cone and the outer wall 54 of the inner end cone 44. Except for connection points along the ends 46, 48 and the inner cone the air gap is preferably continuous to minimize heat transfer to the outer end cone. The spacing between the inner wall of the outer end cone and the outer wall of the inner end cone may vary between the first and second ends 46, 48 but on average should be a distance of at least about 2 mm over the length of the assembly. Depending upon the thermal requirements of the end cone assembly 10, insulation 66 may be provided within the air gap for enhanced thermal dispersion. The insulation can be selected from various known insulation materials but a preferred type of insulation includes ceramic fibers. In addition to effective thermal properties, ceramic fiber insulation tends to dampen vibration.

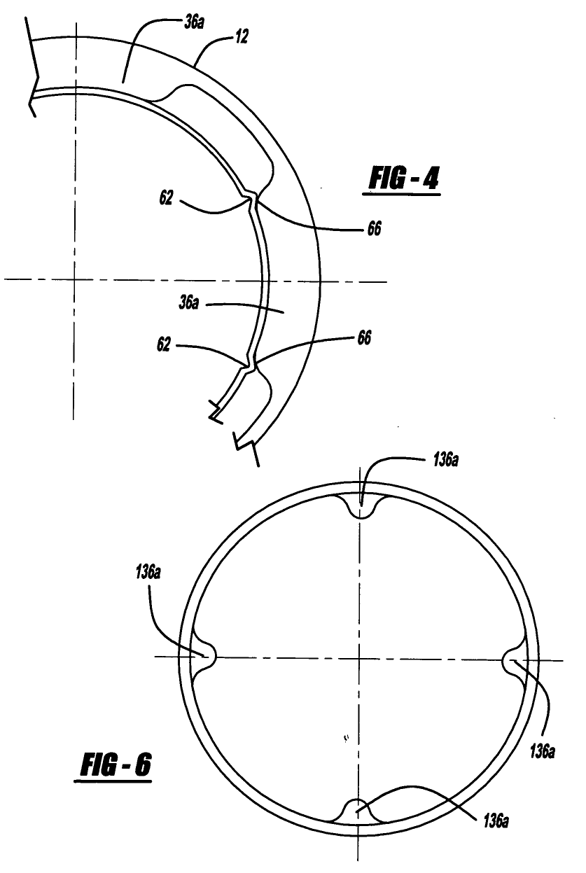

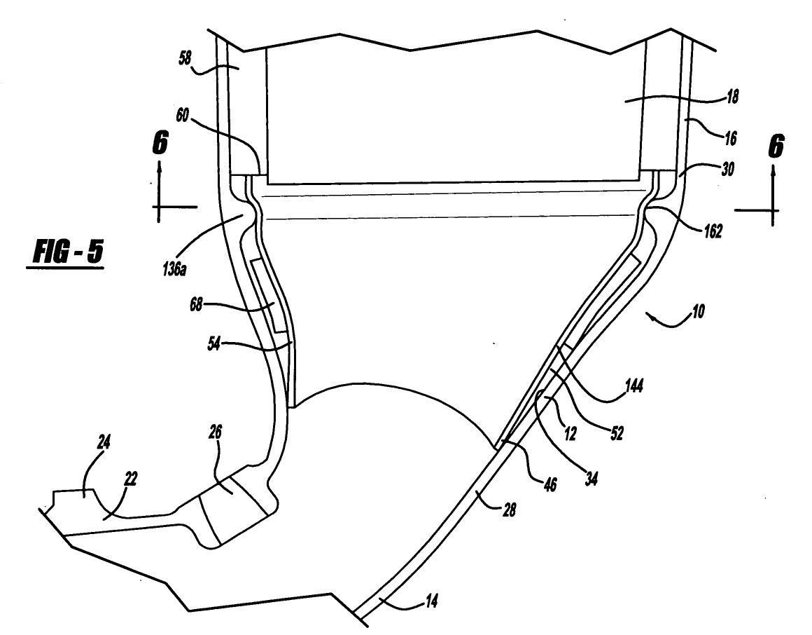

Referring to FIG. 5, an alternative exhaust system end cone assembly employing a snap fit inner end cone 144 is presented. Under this embodiment, the inner end cone 144 includes a circumferential recess 162 which is engaged by the intermittent inwardly projecting flange sections 136a shown most clearly in FIG. 6. The flange sections 136a are substantially rounded to mimic the contour of the recess 162. Essentially all other elements of the assembly remain the same as described above with reference to FIGS. 1-4.

Since the inner cone does not need to function as a structural member of the end cone assembly per se, the inner cone 44 generally only needs enough strength to support itself and some light insulation. Thus, the average thickness of the inner cone 44, when formed from a lightweight stainless steel is typically less than about 1.4 mm, and preferably is between about and 0.8 mm and 1.25 mm. As should now be appreciated, the primary functions of the inner cone are to protect the outer cone from direct exhaust gas impingement thereby lowering its temperature, reducing the heat transfer into the main body of the converter, reducing overall temperature of the main body and mat, and enhancing durability.

The inner cone allows for the outer cone (the main structural piece) to be cast and provide for a gap between the inner and outer cones. The gap can host thermal insulation, which may further protect the cast iron from extreme temperatures. This also protects the exterior of the converter from radiating extreme temperatures and may eliminate the need for external heat shields to protect other under hood components.

The description of the invention is merely exemplary in nature and, thus, variations that do not depart from the gist of the invention are intended to be within the scope of the invention. Such variations are not to be regarded as a departure from the spirit and scope of the invention.

1. An exhaust system end cone assembly comprising:
an outer end cone including a first end connected to a catalytic converter housing and a second end connected to a transition pipe; and
an inner end cone disposed within said outer end cone including one end which seats within said transition pipe and another end which is connected to said outer end cone in proximity to said catalytic converter housing;
whereby said inner end cone is at least partially spaced away from the outer end cone between said first and second ends to provide an air gap therebetween.

2. The end cone assembly of claim 1 wherein said air gap is provided with insulation which serves as a thermal barrier between the inner end cone and outer end cone.

3. The end cone assembly of claim 1 wherein the average distance between the inner end cone and outer end cone along said air gap is at least about 2 mm.

4. The end cone assembly of claim 1 wherein said outer end cone is integrally cast from an iron alloy along with said transition pipe and said catalytic converter housing as a one piece component.

5. The end cone assembly of claim 1 wherein said inner end cone is formed from a heat resistant material selected from the group consisting of stainless steel or ceramics.

6. The end cone assembly of claim 1 wherein said connection between the inner end cone and said outer end cone comprises an inwardly projecting flange disposed along an inner wall of the outer end cone, said flange being engaged by the inner end cone in a press fit relationship.

7. The end cone assembly of claim 6 wherein said inwardly projecting flange includes multiple intermittently disposed flange sections.

8. The end cone assembly of claim 7 wherein said inner cone includes outwardly projecting beads which engage said flange sections to preclude rotation of the inner cone within the assembly.

9. The end cone assembly of claim 7 wherein said inner cone includes an annular recess which is engaged by said intermittently disposed flange sections to retain the inner cone in a snap fit relationship.

10. The end cone assembly of claim 6 wherein said inner end cone includes an outwardly projecting lip which seats upon said inwardly projecting flange.

11. An exhaust conversion assembly comprising:
An end cone assembly including:
(a) an outer end cone formed as part of a one piece component including a catalytic converter housing and a transition pipe; and
(b) an inner end cone disposed within said outer end cone including one end which seats within said transition pipe and another end which is connected to said outer end cone in proximity to said catalytic converter housing;
whereby said inner end cone is at least partially spaced away from the outer end cone between said first and second ends to provide an air gap therebetween.

12. The exhaust conversion assembly of claim 11 wherein said air gap is provided with insulation which serves as a thermal barrier between the inner end cone and outer end cone.

13. The exhaust conversion assembly of claim 11 wherein the average distance between the inner end cone and outer end cone along said air gap is at least about 2 mm.

14. The exhaust conversion assembly of claim 11 wherein said inner end cone is formed from a heat resistant material selected from the group consisting of stainless steel or ceramics.

15. The end cone assembly of claim 11 wherein said connection between the inner end cone and said outer end cone comprises an inwardly projecting flange disposed along an inner wall of the outer end cone engages the inner end cone in a press fit relationship.

16. The end cone assembly of claim 15 wherein said inwardly projecting flange includes multiple intermittently disposed flange sections.

17. The end cone assembly of claim 15 wherein said inner cone includes outwardly projecting beads which engage said flange sections to preclude rotation of the inner cone within the assembly.

18. The end cone assembly of claim 15 wherein said inner cone includes an annular recess which is engaged by said intermittently disposed flange sections to retain the inner cone in a snap fit relationship.

19. The end cone assembly of claim 15 wherein said inner end cone includes an outwardly projecting lip which seats upon said inwardly projecting flange.
